(19) United States
(12) Patent Application Publication
(10) Pub. No.: US 2016/0157281 A1
(43) Pub. Date: Jun. 2, 2016

(54) CONSOLIDATION OF MANAGEMENT COMMUNICATIONS IN A NETWORK ENVIRONMENT

(71) Applicant: Time Warner Cable Enterprises LLC, New York, NY (US)

(72) Inventors: Hussain Zaheer Syed, Ashburn, VA (US); Sunmeel Meelind Bhumkar, Rockville, MD (US); Muhib Taiye Oduwaiye, Germantown, MD (US); Rajesh M. Gangadhar, Ashburn, VA (US); Praveen C. Srivastava, Ashburn, VA (US)

(21) Appl. No.: 14/557,741

(22) Filed: Dec. 2, 2014

(51) Int. Cl. H04W 76/02; H04W 48/16; H04L 12/46

(52) U.S. Cl. CPC H04W 76/023; H04L 12/4641; H04W 48/16

(57) ABSTRACT

A communication resource generates a communication to indicate a primary identifier assigned to a wireless network. Additionally, the communication resource populates the communication with data indicating that the wireless network includes multiple available wireless sub-networks. The communication resource broadcasts the communication as a wireless signal in an airspace. A mobile communication device receives the broadcasted wireless signal. The mobile communication device processes the received wireless signal to learn of a primary identifier assigned to the available wireless network. The mobile communication device further processes the data received in the wireless communication to learn of secondary identifiers (which may require retrieval or be located in the received communication) specifying the different wireless sub-networks that are available. Via selection of one of the secondary identifiers, the user or mobile communication device selects a corresponding one of the multiple available wireless sub-networks to establish a wireless communication link.

### BACKGROUND

Conventional wireless networks typically include multiple communication resources (such as one or more WiFi™ base stations) facilitating wireless communications with one or more mobile communication devices. For example, a conventional wireless network may include: a first base station providing wireless coverage to a first region in a network environment; a second base station providing wireless coverage to a second region in the network environment; etc.

Each of the wireless base stations may be part of the same wireless network providing access to a corresponding remote network such as the Internet. Via communications through a selected one of the multiple base stations, a respective user of the mobile communication device in the home environment is able to wirelessly communicate through a wireless access point over the Internet.

In certain instances, the wireless base stations may support handoffs from one base station to another. This typically requires settings of the wireless base stations to be synchronized to some extent.

A wireless network can include multiple sub-networks (such as wireless LANs), each of which is associated with a different sponsor and, in accordance with the WiFi™ protocol, is assigned a different SSID value. The SSID value (such as a multi-byte character string) assigned to a respective wireless LAN can be a name of the sponsor.

According to conventional techniques, each of multiple wireless sub-networks associated with the wireless access point periodically broadcasts a beacon frame to announce its presence and to relay information, such as timestamp, SSID information, and other parameters regarding the access point to mobile communication devices that are within range. Radio communication devices can be configured to continually scan all 802.11 radio channels and listen for beacons as the basis for choosing which access point is best to establish a respective wireless association.

Thus, to learn of names (SSIDs) assigned to different available wireless LANs in a network environment, a respective mobile communication device can monitor an airspace for beacons broadcasted by each of the wireless LANs. Via the one or more beacons, a respective user of a mobile device is made aware of the presence of the multiple different networks in a respective airspace. The user typically selects amongst the available wireless LANs as indicated by corresponding multiple beacons to establish a respective wireless communication link and access the Internet.

### BRIEF DESCRIPTION OF EMBODIMENTS

Conventional techniques of assigning a unique name (such as an SSID value) to each wireless network suffer from deficiencies. For example, according to conventional techniques, each of the wireless sub-networks (assigned a different SSID value) requires a significant fraction of available shared wireless bandwidth to support management traffic as opposed to client data traffic. Thus, when a network environment includes a large number of sub-networks and corresponding SSIDs, a substantial portion of the limited available wireless bandwidth is needed to support overhead management traffic as opposed to client data traffic.

Embodiments herein deviate with respect to conventional techniques to provide a more efficient use of the available wireless spectrum.

More specifically, in accordance with one example embodiment, a wireless network includes multiple available wireless sub-networks (such as wireless LANs). A communication resource such as a wireless access point generates a communication to indicate a primary identifier assigned to the wireless network. In one embodiment, the wireless network supports open authentication.

In addition to including a primary identifier in the generated communication, the communication resource populates the communication with data indicating that the wireless network is made up of multiple available wireless sub-networks. The communication resource transmits (broadcast) the communication including the data as a wireless signal (such as a beacon) from the communication resource in a respective region of wireless coverage to one or more mobile communication devices present in the respective region.

In one non-limiting example embodiment, the data indicating the sub-network includes one or more bits of information indicating that secondary identifiers associated with the wireless sub-networks are available for retrieval from the communication resource. The secondary identifiers indicate identities of the sub-networks. If desired, a recipient of the communication can initiate retrieval of the secondary identifiers from the communication resource via further communications. Alternatively, if desired, the data populated in the communication can include the secondary identifiers assigned to the sub-networks. In this latter instance, a recipient of the communication need not communicate with the communication resource to retrieve the secondary identifiers.

Assume that a mobile communication device receives the communication as a wireless signal broadcasted by the communication resource. Recall that the wireless communication includes a primary identifier (such as a general name of the wireless network) and corresponding data indicating the secondary identifiers or that secondary identifiers are available. Based on processing of the secondary identifiers, the mobile communication device learns of the names or identities of the multiple available wireless sub-networks in the network environment.

A suitable resource such as a user of the mobile communication device selects a secondary identifier corresponding to a respective sub-network to establish a wireless communication session with the respective sub-network. The mobile communication device transmits the primary identifier and the selected secondary identifier to the communication resource. As mentioned, the selected secondary identifier indicates a particular sub-network of the multiple available sub-networks that the user of the mobile communication device would like to establish a respective wireless communication link with the communication resource.

In this manner, in contrast to each of multiple sub-networks individually competing for wireless bandwidth to broadcast corresponding beacons in a network environment, embodiments herein include broadcasting a communication (such as a shared beacon) from a communication resource. As further discussed below, shared use of a beacon (on behalf of the multiple different wireless sub-networks) according to embodiments herein, as opposed to broadcasting individual beacons for each of the different wireless sub-networks as is the case for conventional techniques, provides substantial savings of available wireless bandwidth in a respective network environment.

In other words, conventional techniques require substantial amounts of bandwidth to transmit individual beacons for each of the different wireless sub-networks supported by a wireless access point. In contrast, embodiments herein reduce the amount of bandwidth that is required to transmit beacons in a wireless network environment based on beacon consolidation. The saved wireless bandwidth (i.e., a portion of bandwidth that is no longer needed for management traffic such as individual beacons from each of the wireless networks) can then be used for better purposes such as conveying data payloads between wireless access points and corresponding mobile communication devices.

Accordingly, embodiments herein increase the percentage of the available wireless bandwidth that can be used to support conveyance of data payloads between communication resources.

These and other more specific embodiments are disclosed in more detail below.

Note that any of the resources as discussed herein can include one or more computerized devices, controllers, set top boxes, servers, base stations, wireless communication equipment, communication management systems, workstations, handheld or laptop computers, or the like to carry out and/or support any or all of the method operations disclosed herein. In other words, one or more computerized devices or processors can be programmed and/or configured to operate as explained herein to carry out different embodiments of the invention.

Yet other embodiments herein include software programs to perform the steps and operations summarized above and disclosed in detail below. One such embodiment comprises a computer program product including a non-transitory computer-readable storage medium (i.e., any physical computer readable hardware storage medium) on which software instructions are encoded for subsequent execution. The instructions, when executed in a computerized device (e.g., computer processing hardware) having a processor, program and/or cause the processor to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One or more embodiments herein include a computer readable storage medium and/or system having instructions stored thereon. In accordance with one embodiment, the instructions, when executed by computer processor hardware, cause the computer processor hardware (such as in a wireless access point) to: generate a communication to indicate a primary identifier assigned to a wireless network supported by the wireless access point; populate the communication with data indicating that the wireless network includes multiple available wireless sub-networks; and transmit the communication as a wireless signal from the wireless access point to a mobile communication device.

Another embodiment herein includes a computer readable storage medium and/or system having instructions stored thereon. The instructions, when executed by computer processor hardware, cause the computer processor hardware (such as in a mobile communication device) to: receive a wireless communication from a wireless access point, the wireless communication including a primary identifier assigned to a wireless network supported by the wireless access point; process data received in the wireless communication, the data indicating that the wireless network includes multiple available wireless sub-networks; and select amongst the multiple available wireless sub-networks to communicate with the wireless access point.

The ordering of the operations above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor, or within an operating system or a within a software application.

As further discussed herein, techniques herein are well suited to automatically update network configuration settings associated with communication resources disposed in a respective subscriber domain. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section and corresponding figures of the present disclosure as further discussed below.

### BRIEF DESCRIPTION OF THE DRAWINGS

FIG. 1 is an example diagram illustrating a network environment and use of stacked SSIDs according to embodiments herein.

FIG. 2 is an example diagram illustrating a primary SSID of wireless network as well as corresponding secondary SSIDs of corresponding wireless sub-networks according to embodiments herein.

FIG. 3 is an example diagram illustrating communications according to embodiments herein.

FIG. 4 is an example diagram illustrating a network environment and use of stacked SSIDs according to embodiments herein.

FIG. 5 is an example diagram illustrating a communication according to embodiments herein.

FIG. 6 is an example diagram illustrating conveyance of communications based on use of secondary SSIDs according to embodiments herein.

FIG. 7 is a diagram illustrating an example computer architecture in which to execute any functionality according to embodiments herein.

FIGS. 8 and 9 are example diagrams illustrating methods according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION AND FURTHER SUMMARY OF EMBODIMENTS

In general, a wireless network includes multiple sub-networks. To advertise presence of the wireless network, a communication resource generates a communication (such as in a beacon) to indicate a primary identifier assigned to the wireless network. Additionally, the communication resource populates the communication with data indicating that the wireless network includes multiple available wireless sub-networks. The communication resource broadcasts the communication as a wireless signal in an airspace. A listening mobile communication device receives the broadcasted wireless signal. The mobile communication device processes the received wireless signal to learn of the primary identifier assigned to the wireless network. The mobile communication device further processes the data received in the wireless communication to learn of secondary identifiers associated with the wireless network. The secondary identifiers may require retrieval or be located in the received communication. The secondary identifiers specify identities of the different wireless sub-networks that are available. Via selection of one of the secondary identifiers, the user or mobile communication device selects a corresponding one of the multiple available wireless sub-networks to establish a wireless communication link. As further discussed herein, use of the primary identifier and the selected secondary identifier enables more efficient use of a wireless spectrum.

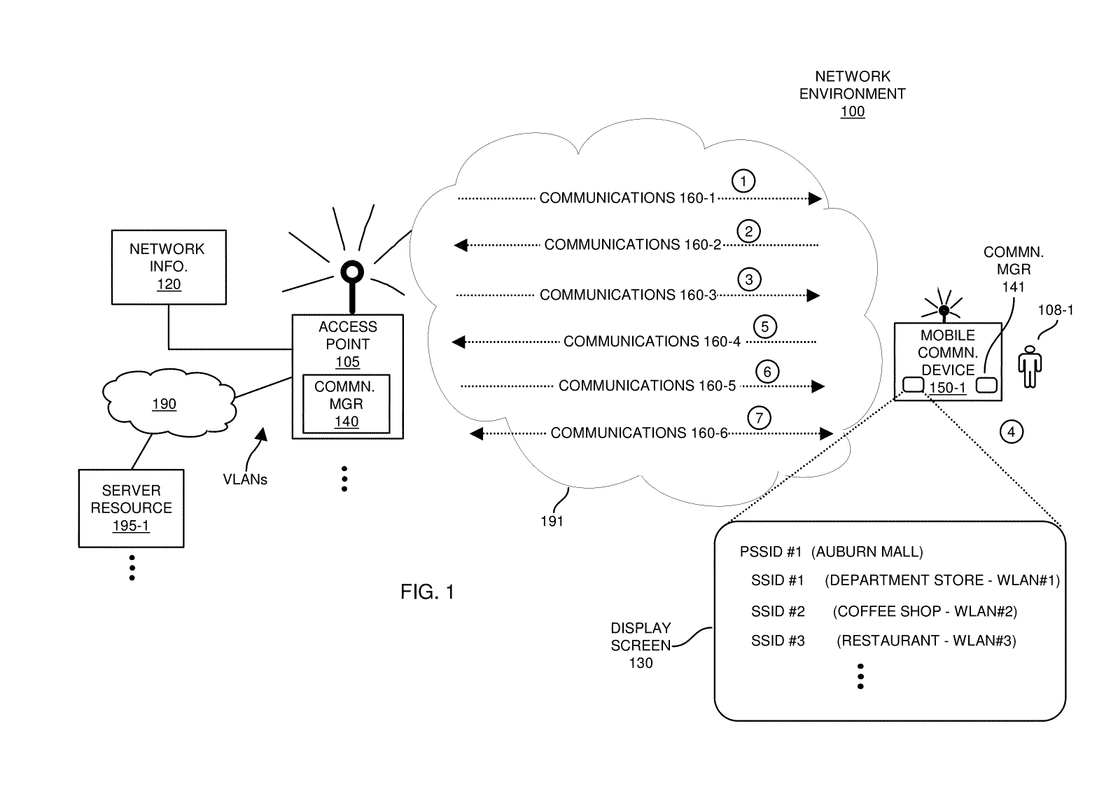

Now, more specifically, FIG. 1 is an example diagram illustrating a network environment according to embodiments herein.

As shown, network environment 100 includes one or more wireless access points including wireless access point 105. The one or more wireless access points in network environment 100 provides one or more users operating respective mobile communication devices 150 access to network 190 (which may include the Internet as well as any other number of networks).

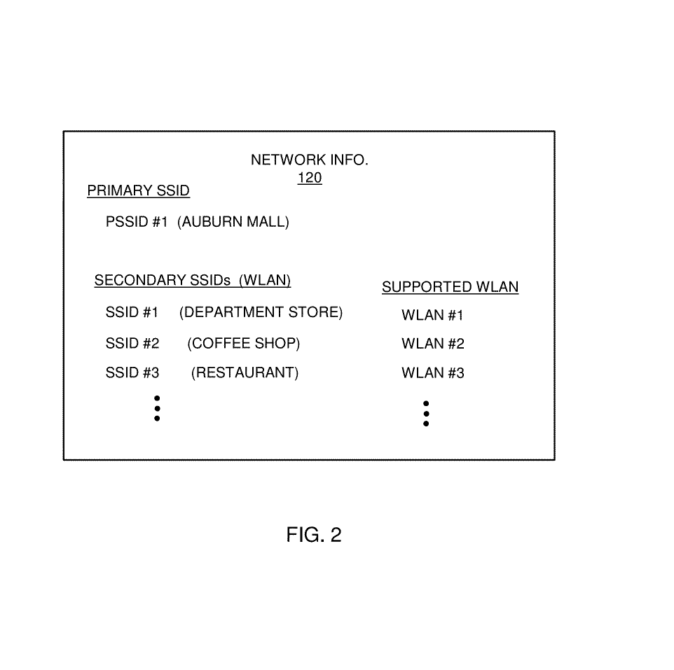

In this example embodiment, in accordance with network information 120 (such as configuration information associated with wireless network 191) more particularly shown in FIG. 2, wireless network 191 includes multiple available wireless sub-networks such as multiple WLANs including WLAN #1, WLAN #2, WLAN #3, etc.

The overall wireless network 191 is assigned a unique identifier PSSID #1, which corresponds to the name of the network such as the “Auburn Mall.” In this example, the name (or unique identifier) assigned to the network indicates its location (i.e., the Auburn Mall).

Further in this example embodiment, in addition to the general wireless network 191 being assigned a unique identifier value of PSSID #1, each of the wireless sub-networks in wireless network 191 is assigned a unique secondary SSID value. For example, as shown in the network information 120 in FIG. 2, assume that the wireless network 191 includes a first wireless sub-network (WLAN #1) assigned secondary SSID #1, a second wireless sub-network (WLAN #2) is assigned secondary SSID #2, a third wireless sub-network (WLAN #3) is assigned secondary SSID #3, and so on.

Each of the sub-networks can be sponsored by a different entity.

Referring again to FIG. 1, each of the wireless sub-networks in network 191 shares use of the same RF (Radio Frequency) spectrum in network environment 100 to communicate with respective target mobile communication devices 150.

Network 191 can be configured to support short-range communications in accordance with any suitable wireless protocol. In one non-limiting example embodiment, the network 191 supports wireless communications in accordance with any of one or more WiFi™ protocols.

To notify respective users and/or the one more communication devices in the network environment 100 of the presence and availability of wireless network 191 and corresponding sub-networks, the communication manager 140 of the wireless access point 105 generates and broadcasts communications 160-1 (such as a wireless beacon) in network environment 100. More specifically, in one embodiment, the communication manager 140 of the wireless access point 105 (i.e., a communication resource) generates communications 160-1 (such as one or more messages, data packets, etc.) to include a primary identifier (e.g., the value PSSID #1, or primary SSID) assigned to the wireless network 191. As previously mentioned, wireless network 191 includes multiple available wireless sub-networks (WLAN #1, WLAN #2, WLAN #3, etc.).

In accordance with further embodiments, in addition to including a primary identifier in the communications 160-1, the communication manager 140 (communication resource) populates the communications 160-1 with data indicating that the wireless network 191 is made up of the multiple available wireless sub-networks.

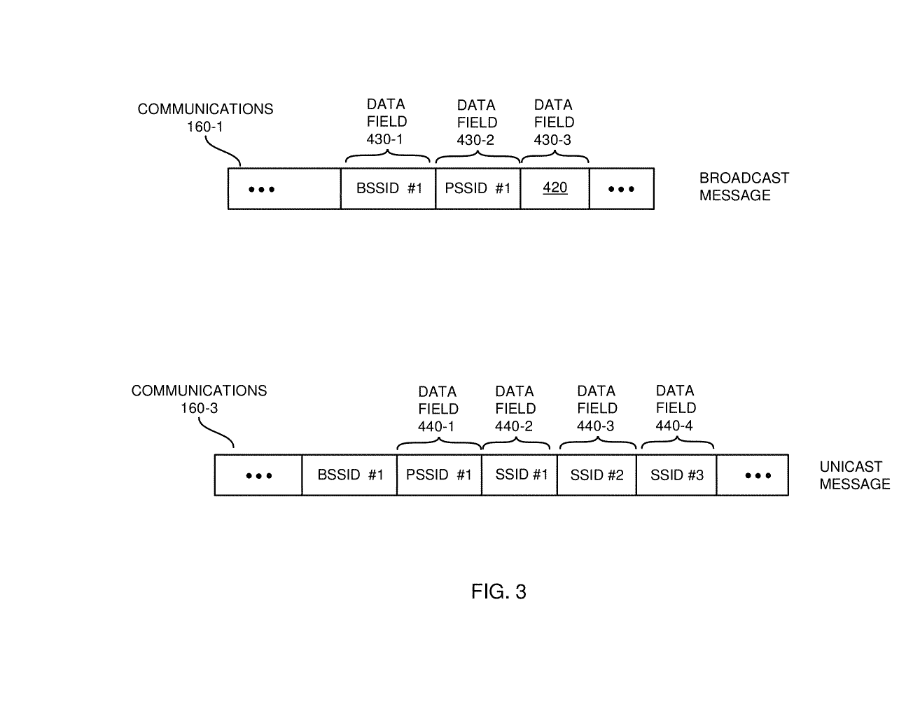

FIG. 3 is an example diagram illustrating communications 160-1 according to embodiments herein.

As shown in this example embodiment, the communication manager populates data field 430-1 with BSSID #1, which is a unique identifier assigned to the wireless access point 105.

In one embodiment, the BSSID is a network address (such as a MAC address) assigned to a respective radio interface of the wireless access point 105 transmitting the wireless communications 160-1. Using the information in the received BSSID #1 in data field 430-1, a respective recipient is able to transmit communications in a reverse direction back to a specific interface on the wireless access point 105 assigned the value BSSID #1.

For example, when communicating in a reverse direction to the wireless access point 105, the transmitting mobile communication device 150-1 includes the BSSID #1 in the subsequent respective wireless communications to indicate that the wireless communications are directed to the corresponding interface of a wireless access point 105.

Additionally, in one embodiment, when generating wireless communications 160-1, the communication manager 140 populates data field 430-2 with the value PSSID #1, indicating the presence and availability of wireless network 191 in network environment 100. The communication manager 140 populates data field 430-3 (reserved bit information or bit) of wireless communication 160-1 with data 420.

The settings of data 420 indicate whether the wireless network 191 includes multiple sub-networks. In this example embodiment, because the wireless network 191 includes multiple sub-networks including WLAN#1, WLAN#2, WLAN#3, etc., the communication resource 140 sets one or more bits in the data 420 of wireless communications 160-1 to an appropriate state indicating that a group of secondary SSID identifiers (such as SSID #1, SSID #2, SSID #3, etc.) are available for retrieval from the communication resource 140.

Referring again to FIG. 1, the communication manager 141 of mobile communication device 150-1 processes the received wireless communications 160-1 including the data as previously discussed. Via data (such as PSSID #1) in data field 430-2, the communication manager 141 of mobile communication device 150-1 learns that the wireless network 191 is assigned PSSID #1.

Via settings of data 420 in data field 430-3, the communication manager 141 detects that wireless network 191 assigned PSSID #1 includes multiple sub-networks. Note that if the wireless network 191 included only one available network, the data 420 in data field 430-3 would alternatively indicate that the wireless network 191 does not include multiple sub-networks.

In this example, the data 420 data field 430-3 indicates that the wireless network 191 includes multiple sub-networks. To learn of the identities of the multiple sub-networks in this example embodiment, the communication manager 141 of mobile communication device 150-1 generates and transmits wireless communications 160-2 (such as a request for configuration information including secondary SSIDs associated with wireless network 191) to communication manager 140.

As previously discussed, the communication manager 141 can include the BSSID #1 (as learned from communications 160-1) in the communications 160-2 to indicate that the communications 160-2 are directed to the specific wireless interface associated with access point 105 generating the wireless communications 160-1. In other words, the wireless communications 160-2 can be a unicast communication.

Accordingly, according to embodiments herein, in response to receiving communications 160-1, the mobile communication device 150-1 generates wireless communications 160-2 to initiate retrieval of the secondary SSID identifiers associated with wireless network 191 from the communication resource 140.

Communication manager 140 of wireless access point 105 receives and processes wireless communications 160-2. In response to receiving the request for secondary identifiers as indicated by wireless communications 160-2, the communication manager 140 generates wireless communications 160-3 as a response to the request for secondary identifiers.

As more specifically shown in FIG. 3, the wireless communications 160-3 includes data field 440-1 indicating an identity of wireless network 191 (namely, PSSID #1). Additionally, the communication manager 140 populates the wireless communications 160-3 to include the names of the sub-networks available in wireless network 191.

In this example embodiment, the communication manager 140 populates data field 440-2 of wireless communications 160-3 to include secondary identifier SSID #1; the communication manager 140 populates data field 440-3 of wireless communications 160-3 to include secondary identifier SSID #2; the communication manager 140 populates data field 440-4 of wireless communications 160-3 with secondary SSID #3; and so on.

In one embodiment, the communication manager 140 executed in wireless access point 105 transmits the wireless medications 160-3 as a unicast message to mobile communication device 150-1. In other words, the wireless communications 160-3 are specifically addressed to mobile communication device 150-1 as opposed to being a broadcast message.

The communication manager 141 of mobile communication device 150-1 receives and processes the wireless communications 160-3. Based on processing of the secondary identifiers present in data fields 440-2, 440-3, 440-4, etc., the mobile communication device 150-1 learns of the names of the multiple available wireless sub-networks in the wireless network 191. More specifically, the communication manager 141 learns that wireless network includes multiple sub-networks including a first sub-network (wireless LAN #1) identified by SSID #1, a second sub-network (wireless LAN #2) identified by SSID #2, a third sub-network (wireless LAN #3) identified by SSID #3, etc.

As further shown, mobile communication device 150-1 can include display screen 130. In one embodiment, the communication manager 141 initiates display of the information received in the wireless communications 160-3 on display screen 130 is shown. Thus, via display screen 130, the user 108-1 is able to learn of a general name of wireless network 191 (i.e., the “Auburn Mall” as specified by PSSID #1) as well as respective names (Department Store as specified by secondary SSID #1, Coffee Shop as specified by secondary SSID #2, Restaurant as specified by secondary SSID #3, etc.) assigned to the different sub-networks that are available in the Auburn Mall.

Note that any suitable resource (such as executing instructions on the mobile communication device 150-1, the user 108-1, etc.) can be configured to select amongst the secondary SSIDs in which to establish a respective communication session between the mobile communication device 150-1 and the wireless access point 105.

In this example embodiment, assume that the user 108-1 (or other suitable resource) selects secondary SSID #2 to establish a wireless communication session between mobile communication device 150-1 and wireless access point 105.

In such an instance, the communication manager 141 generates and transmits wireless communications 160-4 to wireless access point 105. In one embodiment, the wireless communications 160-4 is a probe request message sent prior to association of the mobile communication device with the wireless access point. The mobile communication device 150-1 transmits the wireless communications 160-4 in furtherance of creating an association and establishing a respective wireless session using selected network identified by SSID #2.

In addition to including BSSID #1 to indicate that the wireless communications 116-4 are directed to the wireless access point 105, the communication manager 141 can be configured to generate wireless communications 160-4 to include information such as PSSID #1 and secondary SSID #2 (e.g., the selected sub-network). Inclusion of this information indicates the wireless LAN (wireless LAN #2 in this case) to which the communications pertain.

In response to receiving wireless communications 160-4, the communication manager 140 generates and transmits wireless communications 160-5 to the communication manager 141 in mobile communication device 150. In one embodiment, the wireless communications 160-5 is a probe response transmitted to the mobile communication device 150-1 in response to receiving the probe request (such as wireless communications 160-4).

Note that each of the different wireless LANs may be of a different type and require different security settings, different types of authentication, etc., in order to establish a respective wireless communication session based on the selected secondary SSID.

In one embodiment, as previously discussed, network information 120 indicates a configuration of each of the different types of wireless LANs (sub-networks) in wireless network 191 that are available for use. If desired, the configuration setting of each of the sub-networks depends upon input from respective sponsors.

For example, the department store sponsoring wireless LAN #1 assigned SSID #1 may desire that a first type of security settings, authentication, etc., be used to support new wireless connections; the coffee shop sponsoring wireless LAN #2 assigned SSID #2 may desire that a second type of security settings, authentication, etc., be used to support new wireless connections; the restaurant sponsoring wireless LAN #3 assigned SSID #3 may desire that a third type of security settings, authentication, etc., be used to support new wireless connections; and so on. Network information 120 informs the communication manager 140 of such settings selected by respective sponsors.

Subsequent to establishing the wireless communication session between the mobile communication device 150-1 in the wireless access point 105, both the communication manager 140 and communication manager 141 continue to include the primary SSID (PSSID #1) and selected secondary SSID in respective transmitted wireless communications. In this example embodiment, the communications between wireless access point 105 and mobile communication device 150-1 include PSSID #1 and secondary SSID #2, indicating that the wireless communications 160-6 pertain to WLAN#2, which is a respective sub-network sponsored by the coffee shop.

Accordingly, based on inclusion of the primary identifier and secondary identifier information, each of the communication resources (communication manager 140 and communication manager 141) are aware of the particular wireless network to which the communications 160-6 pertain. In this example embodiment, the inclusion of the secondary SSID #2 in the respective wireless communications 160-6 indicates that the wireless communications 160-6 pertain to wireless network WLAN #2.

In accordance with further embodiments, the communication manager 140 continuously broadcasts wireless communications 160-1 as a beacon such as every 100 milliseconds.

In one embodiment, the wireless communications 160-1 (such as a wireless beacon) includes additional information that is useful for any of the mobile communication devices using wireless network 191, regardless of which particular sub-network they use. For example, the wireless communications 161-1 can include scheduling information (such as random back off timer information) for use by one or more of the mobile communication devices using any of the sub-networks associated with wireless network 191. Additionally, the repeatedly updated and broadcasted wireless communications 160-1 can include information notifying appropriate one or more of the mobile communication devices when corresponding data targeted to the mobile communication devices is available from the wireless access point 105 for retrieval.

In this manner, in contrast to each of multiple sub-networks individually competing for wireless bandwidth to broadcast corresponding beacons in a network environment over a shared radio channel, embodiments herein include repeatedly broadcasting a communication (such as a shared beacon or wireless communications 160-1) from the wireless access point 105.

Shared use of single beacons (on behalf of the multiple different wireless sub-networks) according to embodiments herein, as opposed to broadcasting individual beacons for each of the different wireless sub-networks as is the case for conventional techniques, provides substantial savings of available wireless bandwidth in respective network environment 100. In other words, as previously discussed, conventional techniques require substantial amounts of bandwidth to transmit individual beacons for each of the different wireless sub-networks. In contrast, embodiments herein reduce the amount of wireless bandwidth that is required to transmit beacons in a wireless network environment based on beacon consolidation and sharing.

As a more specific example, conventional techniques would require that each of the wireless LANs transmit their own beacon every 100 milliseconds. If the conventional wireless network included 10 wireless LANs, then 10 beacons would be transmitted every 100 milliseconds. In contrast, instead of broadcasting 10 beacons every one hundred milliseconds, embodiments herein include transmitting a single shared beacon for the wireless network 191 every one hundred milliseconds.

The saved wireless bandwidth (i.e., a portion of bandwidth that is no longer needed for management traffic such as individual beacons from each of the wireless networks) can then be used for better purposes such as conveying data payloads between wireless access points and corresponding mobile communication devices. Accordingly, embodiments herein increase the percentage of the available wireless bandwidth that can be used to support conveyance of data payloads between communication resources.

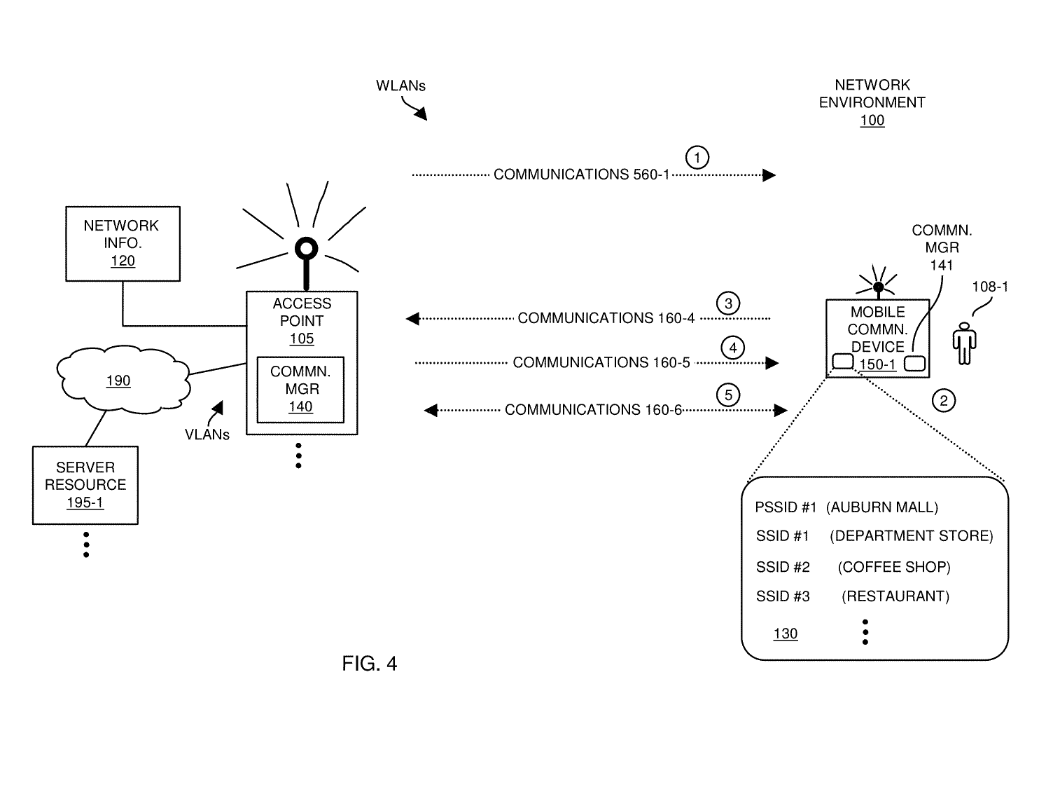

FIG. 4 is an example diagram illustrating network environment and use of stacked SSIDs according to embodiments herein.

As an alternative to requiring the mobile communication device 150-1 to request (such as via wireless communications 160-2) a listing of the secondary SSIDs that are associated with the primary SSID (PSS ID #1), a corresponding beacon message (such as wireless communications 460-1) generated by the wireless access point 105 can be configured to include each of the secondary SSIDs.

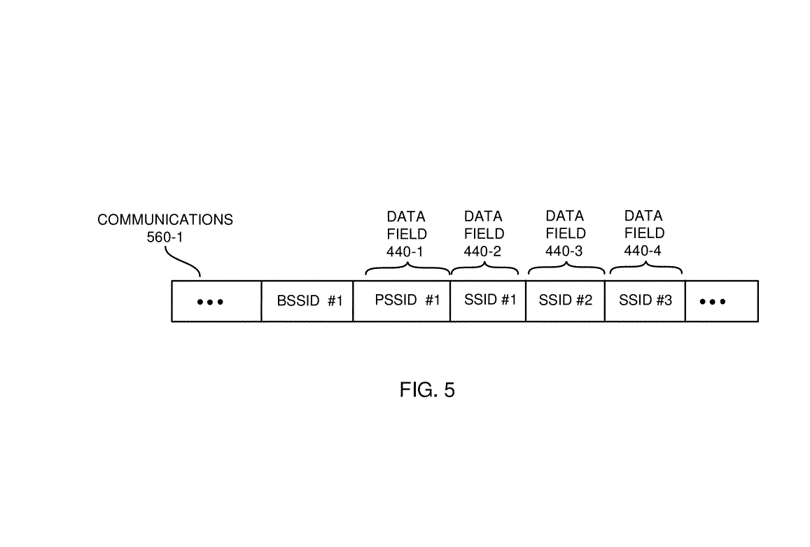

As an example, the communication manager 140 of wireless access point 105 can be configured to generate and broadcast wireless communications 560-1 to mobile communication device 150-1. As shown in FIG. 5, instead of including data 420 indicating that the secondary SSIDs are available for retrieval from the wireless access point 105, the communication manager 140 produces the wireless communications 560-1 to include secondary identifiers. For example, in this example embodiment, the communication resource 140 populates data field 440-1 to include the primary identifier PSSID #1 (indicating presence and availability of a general wireless network 191); the communication resource 140 populates data field 440-2 to include secondary identifier SSID #1 to indicate availability of specific wireless LAN #1; the communication resource 140 populates data field 440-3 to include secondary identifier SSID #2 to indicate availability of specific wireless LAN #2; the communication resource 140 populates data field 440-3 to include secondary identifier SSID #3 to indicate availability of specific wireless LAN #3; and so on.

In accordance with further embodiments, in a similar manner as previously discussed, the communication manager 141 utilizes the information obtained from the received wireless communications 560-1 to display identities of the available wireless sub-networks on display screen 130. As previously discussed, the user 108-1 or other suitable resource such as mobile communication device 150-1 can select from the list of available sub-networks to establish a wireless session with the wireless access point 105.

Further, in a similar manner as previously discussed, via subsequent wireless communications 160-4, 160-5, etc., the mobile communication device 150-1 establishes a respective wireless communication session with the wireless access point 105.

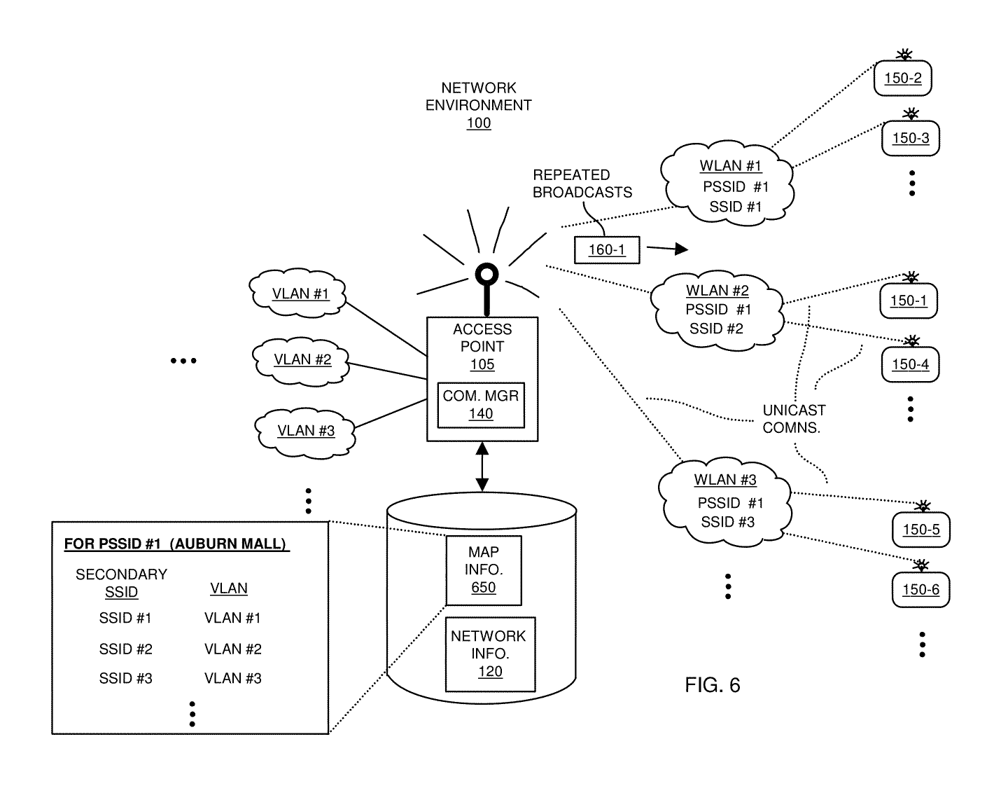

FIG. 6 is an example diagram illustrating conveyance of communications using secondary SSIDs according to embodiments herein.

Subsequent to establishing the wireless communication session between mobile communication device 150-1 and wireless access point 105 over wireless LAN #2 (assigned primary identifier PSSID #1 and secondary identifier SSID #2), the corresponding wireless access point 105 facilitates communications with one or more remote networks such as the Internet, one or more private networks, etc.

In this example embodiment, the communication resource 140 supports switching or routing capability. Assume that mobile communication device 150-2 and mobile communication device 150-3 establish a respective wireless communication link over wireless LAN #1 to wireless access point in a manner as previously discussed. Communications between each of the mobile communication devices 150-2 and wireless access point 105 include primary identifier PSSID #1 and secondary identifier SSID #1.

When further conveying respective traffic from wireless LAN #1 upstream, the wireless access point 105 uses map information 650 to determine which of multiple networks (VLANs) on which to forward communications. For example, in response to receiving an upstream communication from mobile communication device 150-2 including SSID #1, the communication manager 140 in wireless access point 105 maps the secondary identifier SSID #1 to corresponding VLAN #1 using map information 650. In such an instance, the wireless access point 105 forwards the received wireless communication over network labeled VLAN #1. In a reverse direction, communications received over VLAN #1 are retransmitted over wireless LAN #1 using the primary identifier PSSID #1 and secondary identifier SSID #1 to the appropriate target device.

In a similar manner, the communication manager 140 forwards received communications from mobile communication device 150-1 and mobile communication device 150-4 upstream over network VLAN #2.

For example, assume that the mobile communication device 150-1 transmits a wireless communication upstream to wireless access point over wireless LAN #2. As previously discussed, the wireless communications include the primary identifier PSSID #1 and secondary identifier SSID #2. The wireless access point 105 uses the primary identifier and/or secondary identifier in the received wireless communications to determine which of multiple VLANs to forward the communications upstream.

In this example embodiment, the communication manager 140 detects that wireless communications received from mobile communication device 150-1 includes primary identifier PSSID #1 and secondary identifier SSID #2. The communication manager 140 uses map information 650 to determine the network on which to forward the received wireless communications. For example, using the map information 650, the communication manager 140 maps the SSID #2 to VLAN #2. Accordingly, in this example embodiment, the communication manager 140 of wireless access point 105 forwards the received wireless communications over VLAN #2.

Accordingly, in an upstream direction, use of the secondary identifier in received communications indicates on which of multiple networks to forward communications. In a downstream direction, inclusion of the respective secondary identifier indicates which of multiple sub-networks the wireless access point transmits data to one or more target destinations.

Forwarding of received data traffic in accordance with the respective primary identifier and/or secondary identifier is useful because it helps to prevent occurrence of network congestion. In other words, because traffic for the different sub-networks is conveyed to target recipients over different VLANs, no given network (VLAN) is overloaded with data traffic.

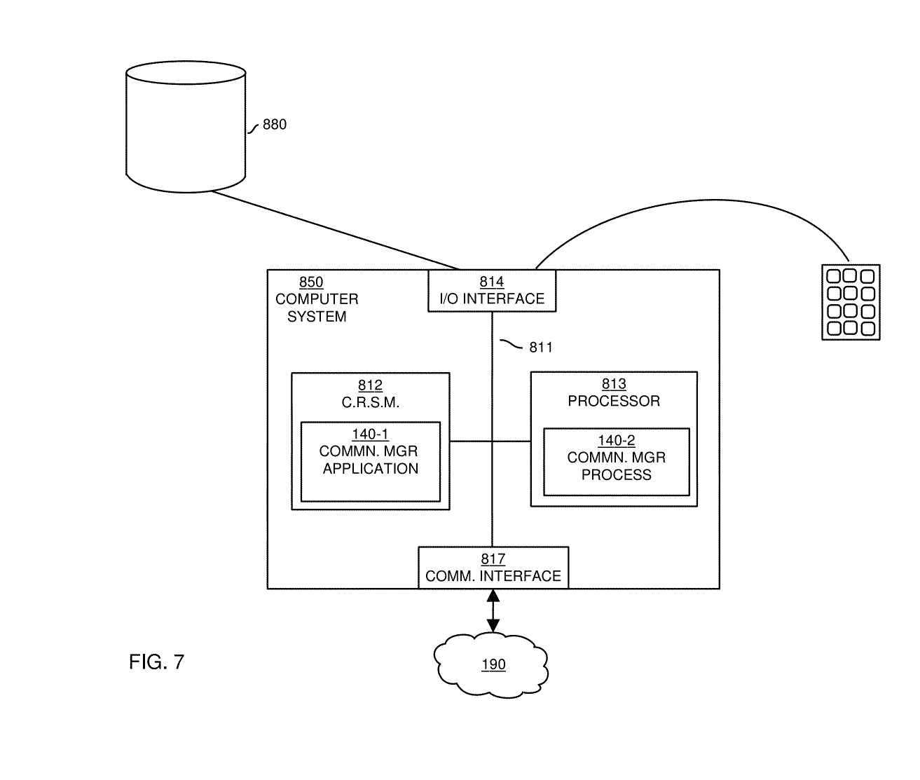

FIG. 7 is an example block diagram of a computer device for implementing any of the operations as discussed herein according to embodiments herein.

In one embodiment, one or more computers (such as wireless access point) implement the communication manager resource 140 and corresponding operations as discussed herein.

As shown, computer system 850 of the present example includes an interconnect 811, a processor 813 (such as one or more processor devices, computer processor hardware, etc.), computer readable storage medium 812 (such as hardware storage to store instructions, data, information, etc.), I/O interface 814, and communications interface 817.

Interconnect 811 provides connectivity amongst processor 813, computer readable storage media 812, I/O interface 814, and communication interface 817.

I/O interface 814 provides connectivity to a repository 880 and, if present, other devices such as a playback device, display screen, input resource 892, a computer mouse, etc.

Computer readable storage medium 812 (such as a non-transitory hardware medium) can be any suitable hardware storage resource or device such as memory, optical storage, hard drive, rotating disk, etc. In one embodiment, the computer readable storage medium 812 stores instructions executed by processor 813.

Communications interface 817 enables the computer system 850 and processor 813 to communicate over a resource such as network 190 to retrieve information from remote sources and communicate with other computers. I/O interface 814 enables processor 813 executing communication manager application 140-1 to retrieve stored information such as from repository 880.

As shown, computer readable storage media 812 is encoded with communication manager application 140-1 (e.g., software, firmware, etc.) executed by processor 813 (hardware). Communication manager application 140-1 can be configured to include instructions to implement any of the operations as discussed herein.

During operation of one embodiment, processor 813 (e.g., computer processor hardware) accesses computer readable storage media 812 via the use of interconnect 811 in order to launch, run, execute, interpret or otherwise perform the instructions in the communication manager application 140-1 stored on computer readable storage medium 812.

Execution of the communication manager application 140-1 produces processing functionality such as communication manager process 140-2 in processor 813. In other words, the communication manager process 140-2 associated with processor 813 represents one or more aspects of executing communication manager application 140-1 within or upon the processor 813 in the computer system 850.

Those skilled in the art will understand that the computer system 850 can include other processes and/or software and hardware components, such as an operating system that controls allocation and use of hardware resources to execute communication manager application 140-1.

In a similar manner, note that computer system 850 can be a respective mobile communication device executing communication manager 141.

In accordance with different embodiments, note that computer system may be any of various types of devices, including, but not limited to, a wireless access point, a mobile computer, a personal computer system, a wireless device, base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, or in general any type of computing or electronic device. The computer system 850 and its parts may reside at any of one or more locations or can be included in any suitable one or more resource in network environment 100 to implement functionality as discussed herein.

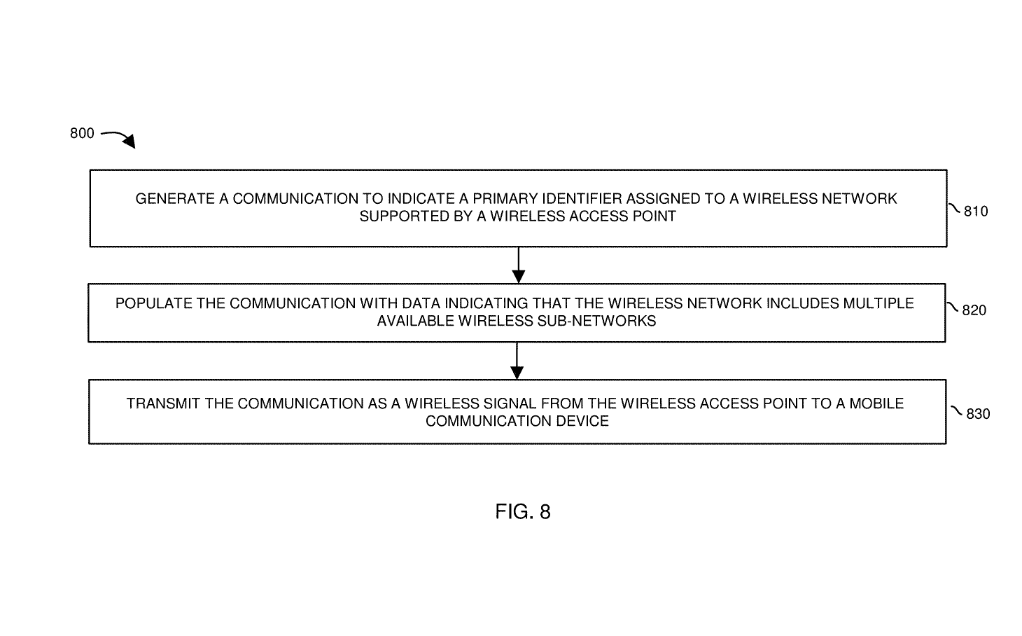

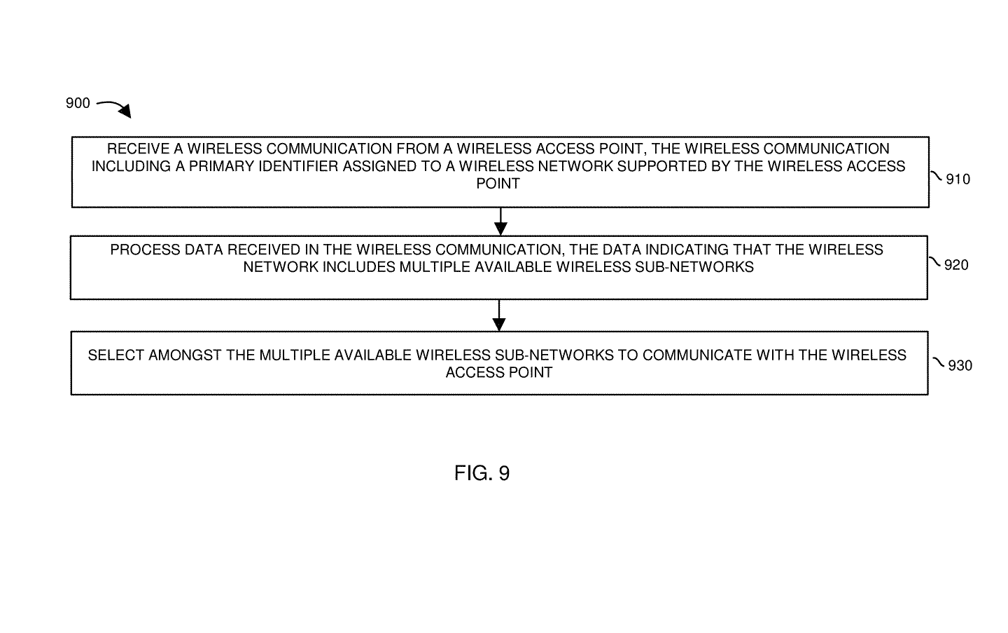

Functionality supported by the different resources will now be discussed via flowcharts in FIGS. 8 and 9. Note that the steps in the flowcharts below can be executed in any suitable order.

FIG. 8 is a flowchart 800 illustrating an example method according to embodiments. Note that there will be some overlap with respect to concepts as discussed above.

In processing block 810, the wireless access point 105 generates a communication (such as wireless communications 160-1) to indicate a primary identifier (such as PSSID #1) assigned to a wireless network 191 supported by the wireless access point 105.

In processing block 820, the wireless access point 105 additionally populates the communication with data 420 indicating that the wireless network 191 as specified by PSSID #1 includes multiple available wireless sub-networks sponsored by different entities.

In processing block 830, the wireless access point 105 transmits (such as broadcasts) the communication as a wireless signal from the wireless access point 105 to a mobile communication device 150-1.

FIG. 9 is a flowchart 900 illustrating an example method according to embodiments. Note that there will be some overlap with respect to concepts as discussed above.

In processing block 910, the mobile communication device 150-1 receives a wireless communication (such as wireless communications 160-1) from wireless access point 105. As previously discussed, the communication includes a primary identifier assigned to wireless network 191 supported by the wireless access point 105.

In processing block 920, the mobile communication device 150-1 processes data 420 received in the wireless communication. The data 420 indicates that the wireless network 191 includes multiple available wireless sub-networks (such as wireless LAN #1, wireless LAN #2, wireless LAN #3, etc.).

In processing block 930, the mobile communication device 150-1 selects amongst the multiple available wireless sub-networks to communicate with the wireless access point 105. Subsequent to making a respective selection, the mobile communication device 150-1 establishes a respective wireless communication session with the wireless access point 105 based on a wireless LAN as specified by the selected one of multiple sub-networks.

Note again that techniques herein are well suited to provide more efficient use of available wireless spectrum when implementing a network environment including multiple individually accessible wireless local area networks. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While one or more inventions have been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
generating a communication to indicate a primary identifier assigned to a wireless network supported by a wireless access point;
populating the communication with data indicating that the wireless network includes multiple available wireless sub-networks; and
transmitting the communication as a wireless signal from the wireless access point to a mobile communication device.

2. The method as in claim 1 further comprising:
receiving a request from the mobile communication device for configuration information indicating identities of the multiple wireless sub-networks; and
in response to receiving the request, transmitting the configuration information to the mobile communication device, the configuration information indicating the identities of the multiple wireless sub-networks.

3. The method as in claim 2, wherein transmitting the configuration information further comprises:
transmitting the configuration information in a unicast message to the mobile communication device.

4. The method as in claim 1, wherein the wireless network supports open authentication.

5. The method as in claim 1, wherein the communication indicates that the wireless network supports multiple secondary SSIDs, the multiple secondary SSIDs specifying identities, security policy information and traffic policy information of the multiple wireless sub-networks.

6. The method as in claim 1, wherein populating the communication with data includes:
setting a bit in a data field of the communication to a predetermined state to indicate that the wireless network includes multiple wireless sub-networks.

7. The method as in claim 1, wherein populating the communication with data includes populating the communication with configuration information indicating identities of each of the multiple wireless sub-networks.

8. The method as in claim 1 further comprising:
receiving a probe request from the mobile communication device, the probe request including the primary identifier assigned to the wireless network and a secondary identifier specifying a selected one of the multiple available sub-networks; and
in response to receiving the probe request: producing a probe response to include the primary identifier and the secondary identifier, and transmitting the probe response to the mobile communication device.

9. The method as in claim 8, wherein producing the probe response to include the primary identifier and the secondary identifier further comprises:
populating data fields of the probe response with the primary identifier and the secondary identifier.

10. The method as in claim 1 further comprising:
establishing a communication session between the mobile communication device and the wireless access point over a selected sub-network specified by a secondary identifier received from the mobile communication device;
receiving communications from the mobile communication over the selected wireless sub-network from the mobile communication device, the received communications including the primary identifier and secondary identifier;
mapping the secondary identifier in the received communications to a VLAN (Virtual Local Area Network) associated with the selected sub-network; and
transmitting the received communications over the VLAN.

11. A method comprising:
receiving a wireless communication from a wireless access point, the wireless communication including a primary identifier assigned to a wireless network supported by the wireless access point;
processing data received in the wireless communication, the data indicating that the wireless network includes multiple available wireless sub-networks; and
selecting amongst the multiple available wireless sub-networks to communicate with the wireless access point.

12. The method as in claim 1, wherein selecting amongst the multiple available wireless sub-networks includes:
transmitting a request from the mobile communication device to the wireless access point for configuration information indicating identities of the multiple available wireless sub-networks; and
in response to transmitting the request, receiving the configuration information at the mobile communication device, the configuration information indicating the identities of the multiple available wireless sub-networks.

13. The method as in claim 12, wherein receiving the configuration information further comprises:
receiving the configuration information in a unicast message transmitted from the wireless access point to the mobile communication device.

14. The method as in claim 11, wherein the wireless network supports open authentication.

15. The method as in claim 11, wherein the wireless communication received from the wireless access point indicates that the wireless network supports multiple secondary SSIDs, the multiple secondary SSIDs specifying identities of the multiple available wireless sub-networks.

16. The method as in claim 11, wherein processing the data received in the wireless communication further comprises:
detecting that a data field of the wireless communication is set to a predetermined state, indicating that the wireless network includes multiple available wireless sub-networks.

17. The method as in claim 11 further comprising:
processing configuration information in the received wireless communication to identify identities of each of the multiple wireless sub-networks.

18. The method as in claim 11 further comprising:
transmitting a probe request from the mobile communication device to the wireless access point, the probe request including the primary identifier assigned to the wireless network and a secondary identifier specifying a selected one of the multiple available sub-networks; and
in response to transmitting the probe request: receiving a probe response including the primary identifier and the secondary identifier.

19. The method as in claim 1, wherein the wireless signal is a broadcast signal.

20. The method as in claim 1, wherein the wireless signal is a broadcasted beacon signal.

21. A computer system comprising:
computer processor hardware; and
a hardware storage resource coupled to the computer processor hardware, the hardware storage resource storing instructions that, when executed by the computer processor hardware, causes the computer processor hardware to perform operations of:
generating a communication to indicate a primary identifier assigned to a wireless network supported by a wireless access point;
populating the communication with data indicating that the wireless network includes multiple available wireless sub-networks; and
transmitting the communication as a wireless signal from the wireless access point to a mobile communication device.

22. The computer system as in claim 21, wherein the computer processor hardware further performs operations of:
receiving a request from the mobile communication device for configuration information indicating identities of the multiple wireless sub-networks; and
in response to receiving the request, transmitting the configuration information to the mobile communication device, the configuration information indicating the identities of the multiple wireless sub-networks.

23. The computer system as in claim 22, wherein the computer processor hardware further performs operations of:
transmitting the configuration information in a unicast message to the mobile communication device.

24. The computer system as in claim 21, wherein the wireless network supports open authentication.

25. The computer system as in claim 21, wherein the communication indicates that the wireless network supports multiple secondary SSIDs, the multiple secondary SSIDs specifying identities of the multiple wireless sub-networks.

26. The computer system as in claim 21, wherein populating the communication with data includes:
setting a bit in a data field of the communication to a predetermined state to indicate that the wireless network includes multiple wireless sub-networks.

27. The computer system as in claim 21, wherein populating the communication with data includes populating the communication with configuration information indicating identities of each of the multiple wireless sub-networks.

28. The computer system as in claim 21, wherein the computer processor hardware further performs operations of:
receiving a probe request from the mobile communication device, the probe request including the primary identifier assigned to the wireless network and a secondary identifier specifying a selected one of the multiple available sub-networks; and
in response to receiving the probe request: producing a probe response to include the primary identifier and the secondary identifier, and transmitting the probe response to the mobile communication device.

29. The computer system as in claim 28, wherein producing the probe response to include the primary identifier and the secondary identifier further comprises:
populating data fields of the probe response with the primary identifier and the secondary identifier.

30. The computer system as in claim 21, wherein the wireless signal is a broadcast signal.

31. The computer system as in claim 21, wherein the computer processor hardware further performs operations of:
establishing a communication session between the mobile communication device and the wireless access point over a selected sub-network specified by a secondary identifier received from the mobile communication device;
receiving communications from the mobile communication over the selected wireless sub-network from the mobile communication device, the received communications including the primary identifier and secondary identifier;
mapping the secondary identifier in the received communications to a VLAN (Virtual Local Area Network) associated with the selected sub-network; and
transmitting the received communications over the VLAN.

32. Computer-readable storage hardware having instructions stored thereon, the instructions, when carried out by computer processor hardware, causes the computer processor hardware to perform operations of:
generating a communication to indicate a primary identifier assigned to a wireless network supported by a wireless access point;
populating the communication with data indicating that the wireless network includes multiple available wireless sub-networks; and
transmitting the communication as a wireless signal from the wireless access point to a mobile communication device.
